(19) United States
(12) Patent Application Publication
(10) Pub. No.: US 2003/0142508 A1
(43) Pub. Date: Jul. 31, 2003

(54) LED lamp

(76) Inventor: Han-Ming Lee, Taipei City (TW)

Correspondence Address: HAN-MING LEE, P.O. BOX 7-820, TAIPEI, TW

(21) Appl. No.: 10/055,697

(22) Filed: Jan. 25, 2002

(51) Int. Cl. F21V 7/04

(52) U.S. Cl. 362/555

(57) ABSTRACT

The present invention relates to an improved structure of a LED lamp, it's comprises an LED bulb comprising two legs each having a peripheral flange; a conductive mechanism consisting of two parallel members each having a post and an upper hook; a block comprising two opposite half-cylindrical grooves and two opposite flexible wedges; and a socket comprising two opposite inner grooves, two first grooves perpendicular to centers of inner grooves respectively, two opposite outer grooves, two half-cylindrical grooves perpendicular to centers of outer grooves respectively, two walls each separated inner groove from outer groove, a space open to bottom, and two opposite openings open to space. Posts are inserted into half-cylindrical grooves of socket, legs are inserted into inner grooves with bottom of LED bulb in contact with top of socket, and block is inserted into space for receiving posts in half-cylindrical grooves of block until wedges are clung into openings.

### BACKGROUND OF THE INVENTION

1. Field of the Invention

The present invention relates to LED (light emitting diode) bulb and more particularly to such an LED lamp with improved characteristics.

2. Description of the Prior Art

Conventionally, a string of incandescent lamps for decoration are used to give off flashing light in Christmas season. Such conventional string of incandescent lamps is disadvantageous because its assembly is time consuming, labor intensive, and error prone. Recently, LED lamps are commercially available. LED bulbs are popular among consumers because they are long in useful life, durable, high quality, and easy in assembly of a string of decorative lamps. But improvement still exists for providing LED bulbs having advantages of high quality, durable and easy in assembly.

### SUMMARY OF THE INVENTION

The main object of this invention is to provide an LED lamp comprising an LED bulb, a conductive mechanism, a socket, and a block. The LED lamp has advantages of easy assembly and durable.

The secondary objective of the present invention is to provide an LED lamp wherein conductive mechanism consists of two parallel members each having two latched pieces fastened in socket.

It is still another object of the present invention to provide an LED lamp wherein LED bulb has two parallel legs each having a latched member at its open end fastened in socket.

It is a further object of the present invention to provide an LED lamp wherein LED bulb has a half-cylindrical projection at either side, socket has two half-cylindrical grooves with half-cylindrical projections inserted into place and two opposite openings at both sides, and block has two flexible wedges clung into openings for fastening.

The above and other objects, features and advantages of the present invention will become apparent from the following detailed description taken with the accompanying drawings.

### BRIEF DESCRIPTION OF THE DRAWINGS

FIG. 1 is a perspective view of a string of LED lamps according to the invention;

FIG. 2 is an exploded view of LED lamp of FIG. 1;

FIG. 3 is a top plan view of socket of LED lamp;

FIG. 4 is an exploded view in part section of LED bulb, socket, and conductive mechanism inserted into socket;

FIG. 5 is a side view in part section showing the assembled LED lamp;

FIG. 6 is an exploded view of conductive mechanism and block; and

FIG. 7 is a perspective view in part section showing the assembled conductive mechanism and block.

### DETAILED DESCRIPTION OF THE PREFERRED EMBODIMENT

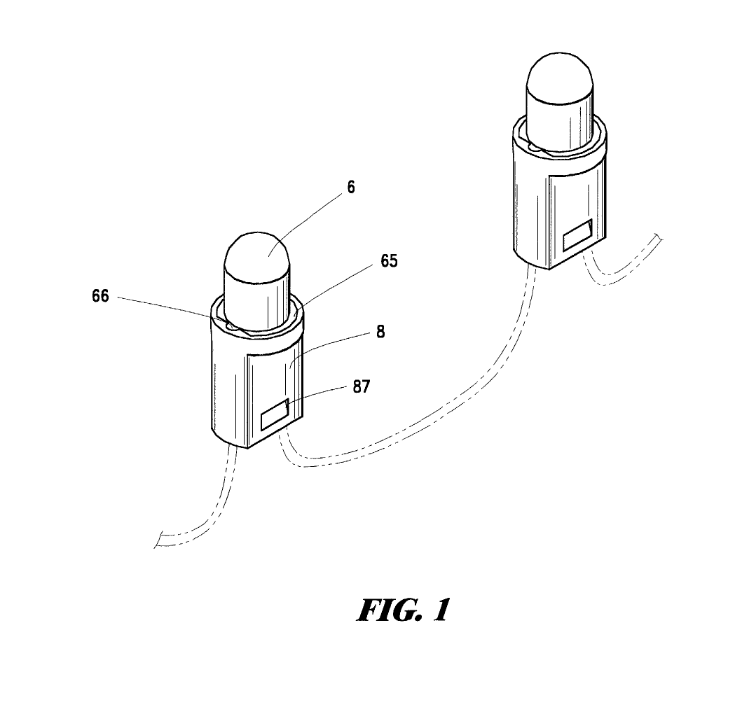

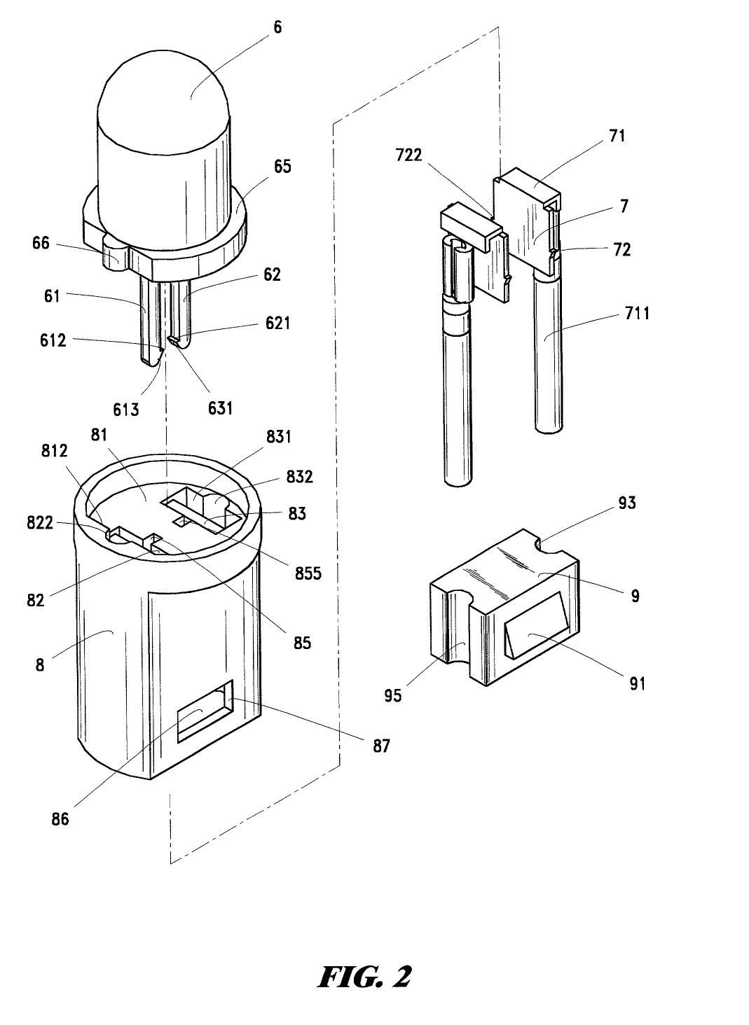

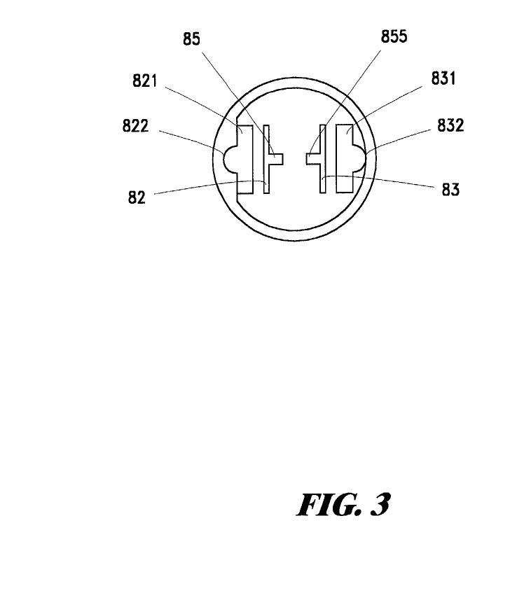

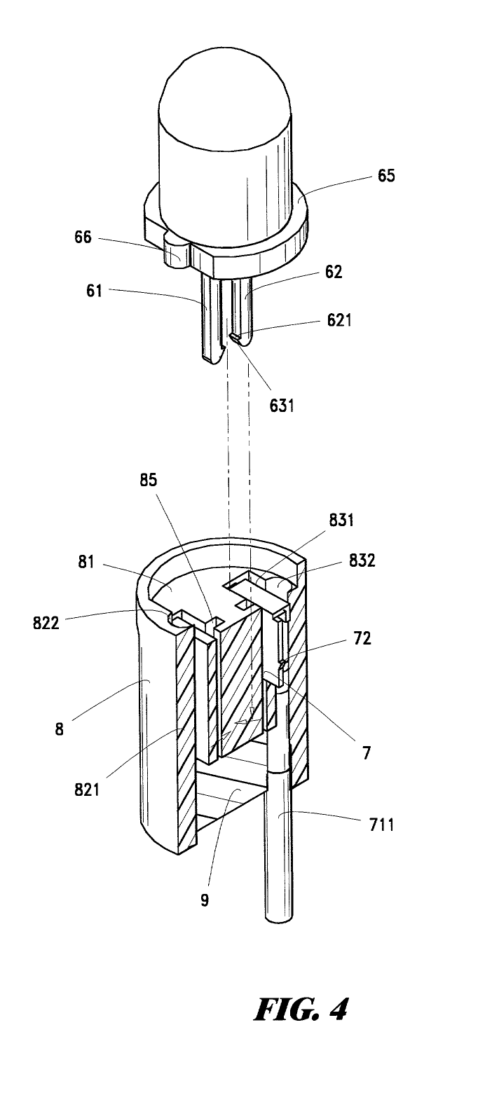

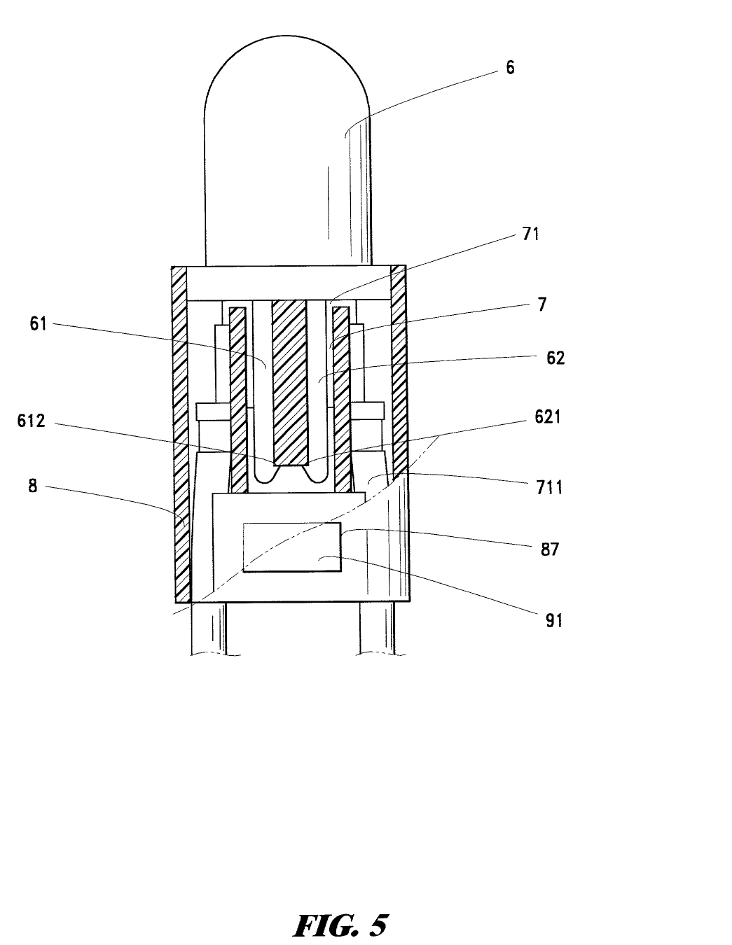

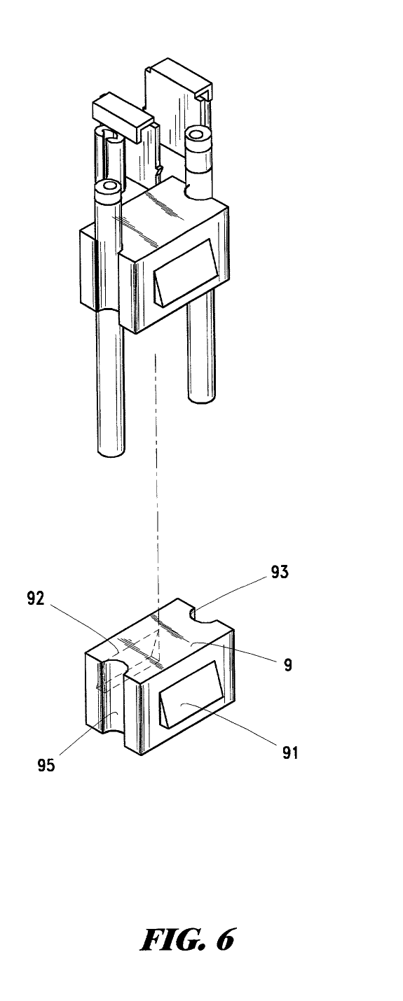

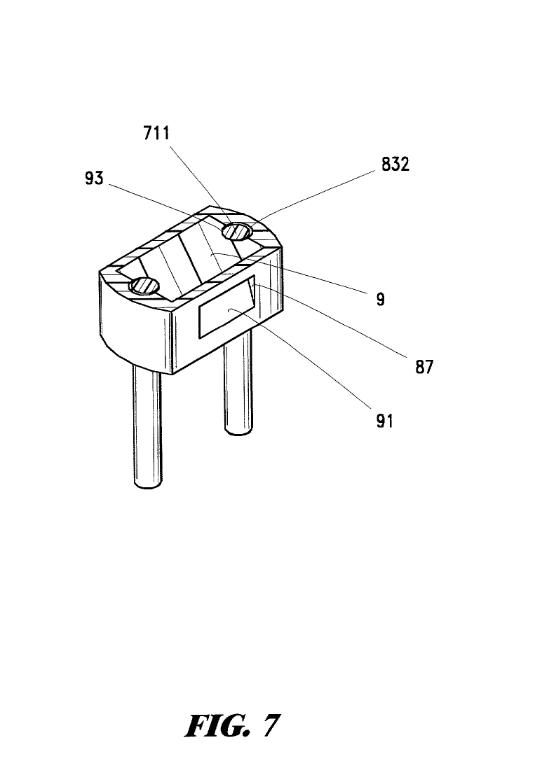

With reference to the drawings and in particular to FIG. 1 to 7, there is shown an LED lamp constructed in accordance with the invention comprising an LED bulb 6, a conductive mechanism 7, a socket 8, and a block 9. Each of above components will now be described in detail below.

LED bulb 6 comprises two legs 61 and 62 each having a latched member 612 (or 621) at its open end and a slip resistant surface 613 (or 631) on latched member 612 (or 621); a peripheral flange 65, and two opposite half-cylindrical projections 66 at the flange 65. Conductive mechanism 7 consists of two parallel members each having a post 711 and a hook 71 at an upper end of the post 711, each hook 71 including two opposite latched pieces 72 and 722. Block 9 comprises two half-cylindrical grooves 93 and 95 at two opposite sides and two opposite flexible wedges 91 and 92 projected from sides between the half-cylindrical grooves 93 and 95. Socket 8 comprises an upper surface 81, two opposite inner grooves 82 and 83, two first grooves 85 and 855 perpendicular to centers of inner grooves 82 and 83 respectively, two opposite outer grooves 821 and 831, two half-cylindrical grooves 822 and 832 perpendicular to centers of outer grooves 821 and 831 respectively, a lower space 86 open to bottom, and two openings 87 each at a flat side open to the space 86.

In assembly, first from top insert the posts 711 inserted into the half-cylindrical grooves 822 and 832 of socket 8 with hooks 71 rested on top edges of walls each separated inner groove 82 (or 83) from outer groove 821 (or 831) and latched pieces 72 and 722 fastened in each of outer grooves 821 and 831. Then insert legs 61 and 62 into inner grooves 821 and 831 respectively until bottom of LED bulb 6 contacts the upper surface 81 of socket 8 with latched members 612 and 621 fastened in place. Next, from bottom insert block 9 into space 86 for receiving posts 711 in the half-cylindrical grooves 93 and 95 of the block 9 until flexible wedges 91 and 92 are clung into openings 87. This finishes the assembly.

While the invention has been described by means of specific embodiments, numerous modifications and variations could be made thereto by those skilled in the art without departing from the scope and spirit of the invention set forth in the claims.

What is claimed is:

1. An LED (light emitting diode) lamp comprising:
an LED bulb comprising two legs each having a latched member at its open end and a peripheral flange;
a conductive mechanism consisting of two parallel members each having a post and a hook at an upper end of the post;
a block comprising two half-cylindrical grooves at two opposite sides and two opposite flexible wedges projected from sides between the half-cylindrical grooves thereof; and
a socket comprising an upper surface, two opposite inner grooves, two first grooves perpendicular to centers of the inner grooves respectively, two opposite outer grooves, two half-cylindrical grooves perpendicular to centers of the outer grooves respectively, two walls each separated the inner groove from the outer groove, a lower space open to a bottom, and two openings each at a flat side open to the space;
wherein in assembly, insert the posts into the half-cylindrical grooves of the socket with the hooks rested on top edges of the walls, insert the legs into the inner grooves respectively until a bottom of the LED bulb contacts the upper surface of the socket with the latched members fastened in place, and insert the block into the space for receiving the posts in the half-cylindrical grooves of the block until the flexible wedges are clung into the openings.

2. The LED lamp as claimed in claim 1, wherein each hook comprises two opposite latched pieces fastened in the socket.

3. The LED lamp as claimed in claim 1, wherein the LED bulb further comprises two opposite half-cylindrical projections at the flange received in the half-cylindrical grooves of the socket.
